(19) United States
(12) Patent Application Publication
(10) Pub. No.: US 2014/0089048 A1
(43) Pub. Date: Mar. 27, 2014

(54) Determining Metrics for Groups of Users Defined by Social Signals of a Social Networking System

(71) Applicant: Sean Bruich, Palo Alto, CA (US)

(72) Inventor: Sean Bruich, Palo Alto, CA (US)

(21) Appl. No.: 13/626,129

(22) Filed: Sep. 25, 2012

(51) Int. Cl. G06Q 30/02; G06Q 50/00

(52) U.S. Cl. CPC G06Q 30/0201; G06Q 50/01
USPC 705/7.32; 705/14.44; 705/7.33

(57) ABSTRACT

A social networking system generates metrics for one or more groups of users defined by various social signals. A group of users may be defined by the users' observed actions in a social networking system and/or the connections between the users' and other social networking system users. Data for the group of users may be compared against data for a control group to generate metrics for the group of users.

### BACKGROUND

This invention relates generally to social networking systems, and more particularly to determining metrics for groups of users defined by social signals of a social networking system.

Many businesses expend significant resources on advertising campaigns promoting a target brand. A typical advertising campaign includes an advertising objective and one or more advertising messages that are communicated to potential customers to meet the objective. One objective of an advertising campaign may be to increase awareness of a target brand. Another objective may be to generate favorable opinions for a target brand. While advertisers often communicate advertising messages from an advertising campaign to potential customers using various forms of media, distribution of advertisements via the Internet is becoming increasingly popular among advertisers. For example, advertisers increasingly distribute advertisements through online social networking systems.

To advertise effectively, advertisers often need metrics related to various groups of the social networking systems. For example, to effectively gauge advertising impact, an advertiser may require the overall value of fans of an associated target brand over social networking systems. But, conventional social networking systems lack mechanisms for delivering useful metrics related to the various groups of the social networking systems.

### SUMMARY

In one embodiment, a social networking system generates metrics for one or more groups of users defined by various social signals. More specifically, the social networking system identifies a group of users based on one or more observed actions performed by users in a social networking system. The social networking system may additionally or alternatively identify the group of users based on a set of connections between users maintained by the social networking system. Data for an identified group of users may then be compared against data for a control group to generate metrics for the group.

In particular, a group of fans of a target brand is identified based on one or more observed actions in a social networking system. As used herein, “fans” of a target brand may include users of a social networking system who have an affinity for the target brand. A user may be identified as a fan of a target brand if the user explicitly indicates that he or she is a fan of the target brand, likes content associated with the target brand, positively comments on content associated with the target brand, joins a group of the social networking system associated with the target brand, shares content over the social networking system associated with the target brand, or takes any action that indicates an affinity for the brand. In addition to identifying a group of fans, a group of friends connected to the fans (hereinafter referred to as an “FoF group”) is also identified. Connections between users maintained by the social networking system are used to identify friends connected to the fans.

In one embodiment, metrics are determined by comparing each of the group of fans and the FoF group to a control group. The metrics measure differences between the control group and the group of fans and the FoF group. In one aspect, the control group includes users of the social networking system that are not fans of the target brand and are not friends of the fans of the target brand. In one embodiment, the control group is a global set of users including users that are representative of the general population of social networking system users. Alternatively, the control group is a set of users having certain characteristics that are similar to characteristics of the group of fans and/or of the FoF group. For example, an overall characteristic profile for fans of a brand indicates the fans have an overall age range of 40-50 years old; hence, the control group may include a set of users having an overall age range of 40-50 years old.

To generate the metrics, one or more polls are provided to the users in each of (1) the group of fans, (2) the FoF group, and (3) the control group. The polls include one or more polling questions relating to the target brand. For example, polling questions may inquire about a user's favorability towards the target brand, the message resonance of the target brand, the purchasing power of the user, etc. Questions in the polls are answered by at least some of the users in each of (1) the group of fans (2) the FoF group, and (3) the control group. Received answers to the polling questions for the group of fans are compared against answers received from the control group to generate various metrics for the groups of fans. Similarly, answers received from the FoF group are compared against answers received from the control group to generate various metrics for the FoF group.

In another embodiment, metrics for the group of fans and the FoF group are generated using holdout subgroups. Metrics generated using holdout subgroups measure the impact of content for a target brand presented over the social networking system on the group of fans and on the FoF group. To calculate metrics using holdout subgroups, the group of fans is partitioned into a fan sample subgroup and a fan holdout subgroup. Similarly, the FoF group is partitioned into a FoF sample subgroup and a FoF holdout subgroup.

The social networking system then withholds or prevents the presentation of content associated with the target brand from the holdout subgroups while presenting the content to the sample subgroups. For example, the social networking system presents an advertisement related to the target brand to the users of the sample subgroups while withholding the advertisement from users in the holdout subgroups. After presentation of the advertisement, polls are provided to each of the subgroups. Based on received answers to questions in the polls, the social networking system generates metrics for the group of fans and the FoF group. Metrics for the group of fans are generated by comparing the polling answers of the fan sample subgroup to the polling answers of the fan holdout subgroup. Similarly, metrics for the FoF group are generated by comparing polling answers of the FoF sample subgroup to polling answers of the FoF holdout subgroup.

By calculating metrics for the group of fans and for the FoF group, an advertiser may effectively evaluate presentation of content associated with a target brand to different groups of users defined by the social networking system. This allows the advertiser to more effectively assess the effectiveness of content associated with a target brand presented to different groups via the social networking system. Hence, advertisers may gain insights to develop effective marketing strategies for different groups.

### BRIEF DESCRIPTION OF THE DRAWINGS

FIG. 1 is a high level block diagram of a process for generating metrics for groups of users defined by social signals, in accordance with one embodiment of the invention.

FIG. 2 is a high level block diagram of a social networking system, in accordance with one embodiment of the invention.

FIG. 3 is a flow chart of a process for generating metrics based on groups defined by social signals, in accordance with an embodiment of the invention.

FIGS. 4A and 4B are diagrams illustrating generation of metrics and reports based on groups defined by social signals, in accordance with an embodiment of the invention.

FIG. 5 is a flow chart of a process for generating metrics for groups using holdout subgroups, in accordance with an embodiment of the invention.

The figures depict various embodiments of the described methods and system and are for purposes of illustration only. One skilled in the art will readily recognize from the following discussion that alternative embodiments of the methods and systems illustrated herein may be employed without departing from the principles of the methods and systems described herein.

### DETAILED DESCRIPTION

### Overview

A social networking system offers its users the ability to communicate and interact with other users of the social networking system. Users join the social networking system and add connections to other users to which they desire to be connected. At least some of these connections may be considered “friendship” type connections. Users of the social networking system may provide information about themselves, which is stored as user profiles. For example, users may provide their age, gender, geographical location, educational history, employment history and/or the like. The information provided by users may be used by the social networking system to direct information to the user. For example, the social networking system may recommend social groups, events, other social networking objects, and potential connections (e.g., friends) to a user. A social networking system may also enable users to explicitly express interest in objects and/or concepts, such as brands, products, celebrities, hobbies, sports teams, music, and the like. These interests may be used in a myriad of ways, including targeting advertisements and personalizing the user experience on the social networking system by showing relevant stories about other users of the social networking system based on shared interests.

The social networking system maintains and stores a social graph. The social graph includes nodes connected by a set of edges. Nodes represent users and other objects of the social networking system, such as web pages embodying concepts and entities, and edges connect the nodes. Each edge represents a particular interaction or connection between two nodes, such as a user expressing an interest in a news article shared by another user about “America's Cup.” As another example, an edge may represent a connection (e.g., a friendship type relationship) established between two users. As such, the social graph includes data representative of the social signals of the social networking system. In one embodiment, the social networking system generates the edges of the social graph based on the observed actions of its users.

Social signals of the social graph may be used by the social networking system to identify various groups of users. For example, users with certain edges or types of edges to a social networking object (e.g., a fan page) are determined to be part of a group of fans associated with the social networking object. Similarly, users with certain edges or types of edges to a particular user in the group of fans are determined to be part of a group of friends of the particular user.

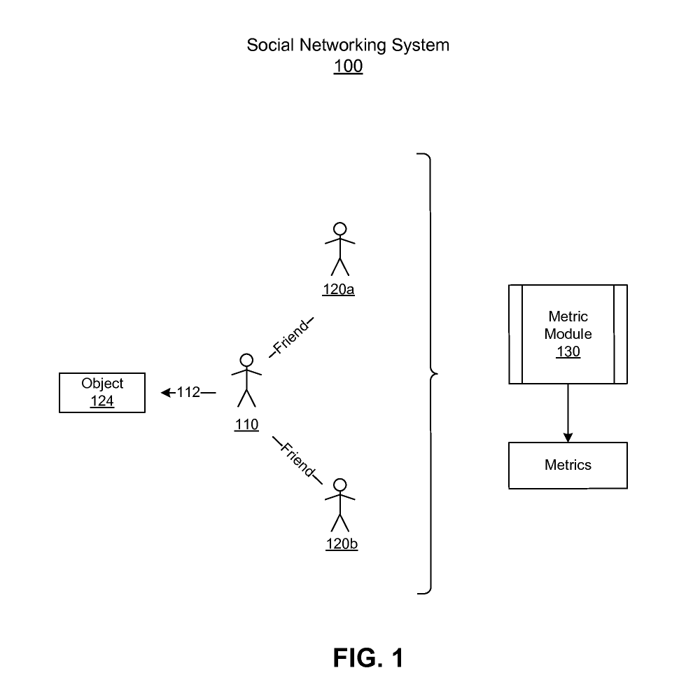

FIG. 1 is a high level block diagram of a process for generating metrics for groups of users defined by social signals. As shown in FIG. 1, the social networking system 100 includes a metric module 130, which generates metrics for one or more groups of users defined by various social signals of the social networking system 100. The groups of users may be defined based on various user actions in the social networking system 100 and/or connections maintained by the social networking system 100.

In the example of FIG. 1, a user 110 performs an action 112 involving a social networking object 124, which includes any suitable content associated with a target brand. For example, the social networking object 124 is a fan page including posts and comments related to a particular target brand. The action 112 may be any suitable interaction capable of identifying the user 110 as a fan of the brand. For example, the action 112 may be an interaction that expresses the user 110's preference for the social networking object 124 associated with the brand (also referred to as “liking” the brand) or the action 112 may be an interaction that indicates the user 110's establishment of a connection with the social networking object 124.

After identifying the user 110 as a fan of the brand based on the action 112, the metric module 130 assigns the user 110 to a group including fans of the brand. The metric module 110 subsequently identifies additional users having a specified type of connection to the user 110 in the social networking system 100. For example, the metric module 110 identifies additional users having a connection type indicating a friendship to the user 110. In FIG. 1, the users 120a, 120b are friends of the user 110 in the social networking system 100. Accordingly, the metric module 130 includes users 120a and 120b in a group of users that are friends connected to fans of the brand, also referred to as an “FoF group” for the brand. After determining the group including fans of the brand and the FoF group, the metric module 130 generates metrics for the group of fans and the FoF group as further described below.

### System Environment

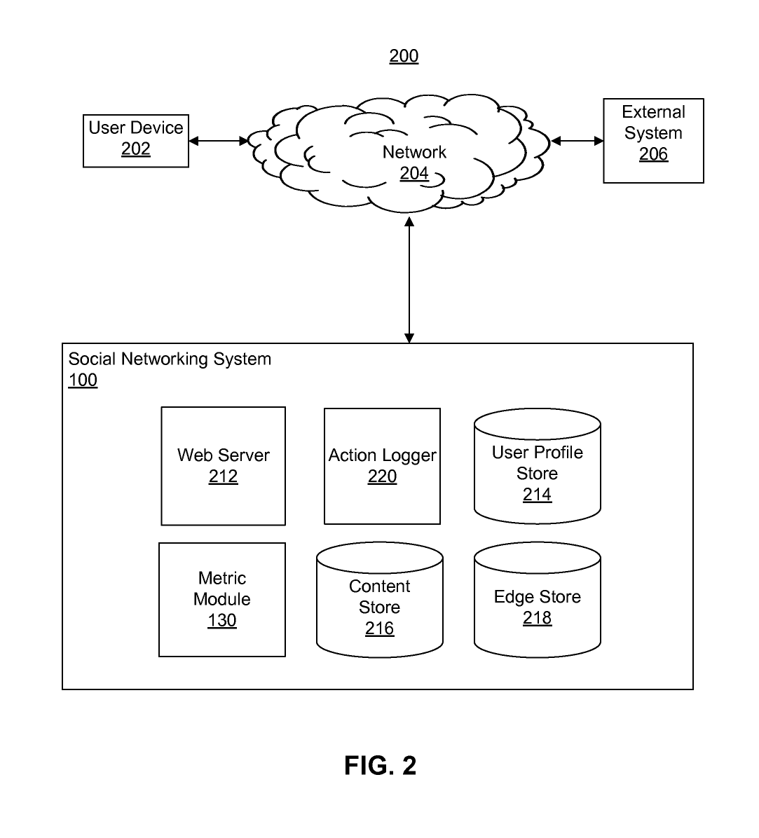

FIG. 2 is a high level block diagram of one embodiment of a system environment 200. In the example shown by FIG. 2, the system environment 200 includes one or more user devices 202, the social networking system 100, a network 204, and one or more external systems 206 (e.g., third party websites, etc.). For purposes of illustration, the embodiment of the system environment 200 shown in FIG. 2 includes a single external system 206 and a single user device 202. However, in other embodiments, the system environment 200 may include more user devices 202 and/or external systems 206.

In some embodiments, the social networking system 100 is implemented as a single server, while in other embodiments it is implemented as a distributed system of multiple servers. For clarity, the social networking system 100 is described below as being implemented on a single server system. In certain embodiments, the social networking system 100 is operated by a social network provider, and the external systems 206 are separate from the social networking system 100 by being operated by different entities. In various embodiments, however, the social networking system 100 and the external systems 206 operate in conjunction to provide social networking services to users of the social networking system 100. The external system 206 is coupled to the network 204 to communicate with and/or provide various functionalities to the social networking system 100. Hence, the social networking system 100 provides a platform, or backbone, which other systems, such as the external system 206, may use to provide social networking services and functionalities to users.

The network 204 may be any wired or wireless local area network (LAN) and/or wide area network (WAN), such as an intranet, an extranet, or the Internet. The network 204 provides communication capability between the user devices 202, the external systems 206, and the social networking system 100. In some embodiments, the network 204 uses the HyperText Transport Protocol (HTTP) and the Transmission Control Protocol/Internet Protocol (TCP/IP) to transmit information between devices or systems. The various embodiments of the invention, however, are not limited to the use of any particular protocol.

The user device 202 is a computing device capable of receiving user input as well as transmitting and receiving data via the network 204. In one embodiment, the user device 202 is a conventional computer system, such as a desktop computer or a laptop computer. In another embodiment, the user device 202 is a device having computer functionality, such as a personal digital assistant (PDA), mobile telephone, smartphone, etc. The user device 202 is configured to communicate via network 204. The user device 202 can execute an application, for example, a browser application allowing a user of the user device 202 to interact with the social networking system 100. In another embodiment, the user device 202 interacts with the social networking system 100 through an application programming interface (API) that runs on a native operating system of the user device 202.

The social networking system 100 comprises a computing system that allows users to communicate or otherwise interact with each other and access content as described herein. As further described herein, the social networking system 100 stores user profiles describing its users, including biographic, demographic, and other types of descriptive information. Examples of information stored in user profiles include work experience, educational history, hobbies or preferences, location, and the like. The social networking system 100 also stores other objects, such as fan pages, events, groups, advertisements, general postings, etc.

The web server 212 links the social networking system 100 via the network 204 to one or more user devices 202; the web server 212 also serves web pages and other web content, such as JAVA®, FLASH®, XML, and so forth. The web server 212 may receive and route messages between the social networking system 100 and the user devices 202. Examples of messages include instant messages, queued messages (e.g., email), text and SMS (short message service) messages, or messages sent using any other suitable messaging technique. A user can send a request to the web server 212 to upload information, such as images or videos, stored in the content store 216.

The user profile database 214 stores user profiles including declarative profile information about users. The profile information includes inferred and/or implicit information about the user from the user's actions on the social networking system 100, the user's actions outside of the social networking system 100, information about the user's activities and interests, and/or information about the user's friends or other connections in the social networking system 100. A user's profile information stored in a user profile includes biographic, demographic, and other types of descriptive information, such as work experience, educational history, gender, hobbies or preferences, location, and the like.

In one embodiment, a user profile includes various data fields for storing information items about a user. Each data field may store a different type of information. Examples of information stored by the data fields include phone numbers, instant message screen names, addresses, websites, current city, hometown, gender, birthday, names of family members, languages spoken, a description, educational history, work history, religious affiliations, political views, favorite quotes, favorite sports, favorite foods, favorite books, favorites movies, interests, activities, names of pets, information about friends, and the like.

The content database 216 stores various social networking objects of the social networking system 100. Such objects may include fan pages, events, groups, software applications, etc. The content database 216 additionally stores more granular objects such as page posts, status updates, photos, videos, links, shared content items, gaming application achievements, check-in events at local businesses, and so on. The social networking system objects include objects created by users of the social networking system 100, such as status updates that may be associated with photo objects, location objects, and other users, photos tagged by users to be associated with other objects in the social networking system 100, such as events, pages, and other users, and applications installed on the social networking system 100. In some embodiments, the objects are received from third-party applications separate from the social networking system 100.

The action logger 220 receives communications from the web server 212 about user actions on and/or external to the social networking system 100. The action logger 220 populates the edge store 218 with information about user actions, allowing the social networking system 100 to track various actions taken by its users within the social networking system 100 and outside of the social networking system 100. Any action that a particular user takes with respect to another user or social networking system object is associated with each user's profile through information maintained in the edge store 218 or in a similar data repository. Examples of actions taken by a user within the social networking system 100 that are identified and stored may include, for example, adding a connection to another user, sending a message to another user, reading a message from another user, viewing content associated with another user, attending an event posted by another user, becoming a fan of a social networking object, liking a social networking object, commenting on a social networking object, sharing information about a social networking object, and/or other actions.

The edge store 218 stores edge objects connecting nodes in a social graph maintained by the social networking system 100. As discussed, each node can represent a user or other social networking object. Edge objects include information about a user's interactions with other objects on the social networking system 100. Examples of interactions with other objects include: accessing a link shared by other users, sharing photos with other users, posting a status update message, and/or other actions that may be performed inside of and outside of the social networking system 100. Edge objects may include information about a connection between social networking objects. For example, an edge object includes an affinity value or coefficient value for a user with respect to objects, interests, and other users. Affinity values may be computed by the social networking system 100 over time to approximate a user's affinity for an object, interest, and other users in the social networking system 100 based on the actions performed by the user. In one embodiment, multiple interactions between a user and a specific object may be stored in one edge object in the edge store 218. For example, a user that plays multiple songs from Lady Gaga's album, “Born This Way,” may have multiple edge objects for the songs, but only one edge object for Lady Gaga. Edge objects may also include information about user interactions outside of the social networking system 100. For example, interaction information may be collected from third-party systems (e.g., sites and applications) using social plug-ins enabling interaction with content from the social networking system 100. Coefficient values are further described in U.S. application Ser. No. 12/978,265, titled “Contextually Relevant Affinity Prediction in a Social Networking System,” filed Dec. 23, 2010, the contents of which are incorporated herein by reference in their entirety.

Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 100, such as expressing interest in a page on the social networking system 100, sharing a link with other users of the social networking system 100, becoming a fan of a page, etc.

The metric module 130 identifies a group of fans for a target brand based on one or more interactions performed by the fans on the content of the brand. Additionally, the metric module 130 identifies users connected to fans of the brand (a “FoF group: of a brand). The FoF group includes users of the social networking system 100 connected via the social networking system 100 to at least one user included in the group of fans of the brand. In one embodiment, the FoF group includes users connected to at least one user in the group of fans by a specific type of connection (e.g., friendship type connections). As further described below, the metric module 130 generates metrics for the group of fans and for the FoF group.

### Process for Generating Metrics for Groups Defined by Social Signals

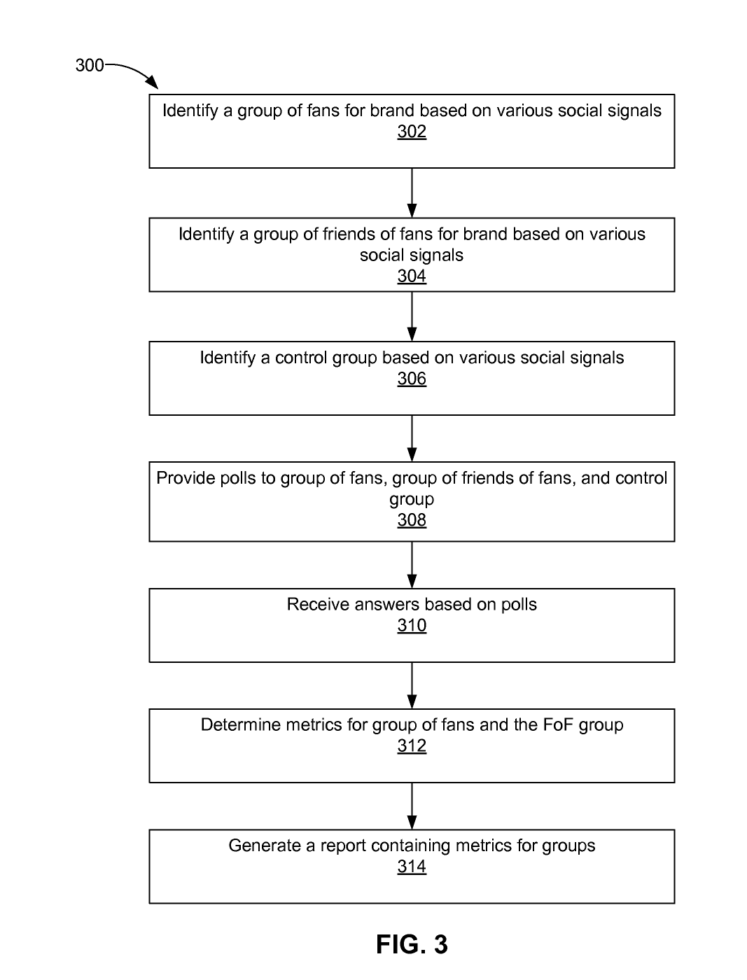

FIG. 3 illustrates one embodiment of a process 300 for generating metrics for one or more groups defined by social signals. In the process, a group of fans of a target brand are identified 302 based on various social signals. More specifically, users of the social networking system 100 in the group of fans are identified based on actions performed by the users, where the actions are explicitly indicative of being fans of the target brand. For example, users that have explicitly “become a fan” of the target brand over the social networking system 100 are identified as members of the group of fans for the target brand. In one embodiment, users in the group of fans are additionally or alternatively identified based on actions performed by the users, where the actions express an implicit affinity for the target brand. For example, a user may be identified as a fan based on instances where the user has indicated a preference for (i.e., “liking”) content associated with the target brand, shared content associated with the target brand, commented positively on the target brand, mentioned the target brand in posts or statuses, or otherwise directly interacted with content of the target brand without explicitly becoming a fan of the target brand. A user may also be identified as a fan through inferring that a user has mentioned the target brand in the user's content through dark tagging. Dark tagging is further described in U.S. application Ser. No. 12/589,693, titled “Providing Content Using Inferred Topics Extracted from Communications in a Social Networking System,” filed Aug. 20, 2012, the contents of which are incorporated herein by reference in their entirety.

In one specific embodiment, edges in the edge store 218 are used to identify the users in the group of fans. More specifically, social networking objects (e.g., fan pages, etc.) associated with the target brand are identified. Thereafter, a set of users connected to the identified social networking objects via one or more edges are determined. Users in the set that are connected to the identified social networking objects via edges that have affinity values exceeding a threshold value are determined to be fans of the target brand. For example, the threshold value for a target brand may be 0.5. If a user explicitly becomes a fan of a social networking object associated with the target brand, an edge having an affinity value of 1.0 is generated between the user and the social networking object. Because the affinity value of the edge generated by the user explicitly becoming a fan exceeds the threshold value, the user is identified as a fan of the target brand.

Based on the group of fans of the target brand and various social signals associated with users in the group of fans of the target brand, a group of friends of the fans (FoF group) is identified 304. More specifically, for each user in the identified group of fans of the target brand, those users having a friendship type connection with the user in the group of fans are identified. The identified users are included in the FoF group. In one implementation, the “friends” of the users in the group of fans of the target brand are determined based on the edges in the edge store 218.

Based on one or more social signals, a control group of users is identified 306. In various embodiments, the control group of users includes users that are not identified as fans of the target brand and are not friends of the fans of the target brand. For example, users included in the control group are users that did not perform actions indicating an affinity surpassing a threshold value for the target brand. In addition, each user in the control group does not have a specified type of connection (e.g., a connection indicating friendship) with the identified fans of the target brand. In one embodiment, the users in the control group may not be users of the social networking system.

In one embodiment, the control group of users is randomly or pseudo-randomly selected from the general population of social networking system users. This enables the control group to have characteristics that are statistically similar to the general population of social networking system users. In another embodiment, the control group has certain characteristics statistically similar to those of the group of fans and/or the FoF group. For example, certain characteristics of the users in the group of fans and/or users in the FoF group are identified. Examples of identified characteristics include average age, overall shared interests, average geographic location, gender, etc. Based on the identified characteristics, a control group is identified from the general population of the social networking system, where the users selected from the general population have characteristics statistically similar to one or more of the identified characteristics for the group of fans and/or the FoF group. As an example, the group of fans and/or the FoF group may have an average age range of 35-50 years old. Thus, a control group may be identified as a group of users of the social networking system having the same average age range of 35-50.

Polls are provided 308 from the social networking system 100 to the group of fans of the target brand, the FoF group, and the control group. The polls include one or more questions suitable for capturing data for generating metrics for the group of fans and for the FoF group. For example, data describing one or more polling questions may be retrieved. The polling questions may then be provided to the group of fans of the target brand, the FoF group, and the control group. In one embodiment, the polling questions include questions related to the purchasing power of the groups. For example, a polling question may ask how much a user in a group has spent on products (e.g., physical items, intangible items, or services) associated with the target brand in the last week, month, year, etc. As another example, a polling question may ask a user how much the user plans to spend on products associated with the target brand in the next week, month, or year.

The polling questions may also include questions related to brand equity. For example, a polling question may ask a user to rate the user's perception of the target brand. Alternatively, a polling question may ask a user to select the user's favorite brand out of a group of brands including the target brand. As another example, a polling question may ask for the likelihood a user would recommend products associated with the target brand.

The polling questions may further include questions related to message resonance. For example, a polling question may ask how closely a user believes the core positioning of the target brand. Illustratively, an automobile manufacturer may market its brand as associated with safety. Accordingly, a polling question may ask how much a user believes that the automobile manufacturer's products are safe. Thereafter answers are received 310 based on the provided polls from the group of fans, the FoF group, and the control group.

In other embodiments, the data used to generate the metrics for the group of fans and the FoF group may be obtained through other means in addition to or alternatively to providing polling questions and receiving corresponding polling answers. For example, the data for the group of fans, FoF group, and/or control group needed to generate the various metrics for the group of fans and FoF group may be obtained through receiving answers to questions posted over the social networking system to the various groups; receiving answers to questions posed to friends of the fans or friends of the users in the FoF group; evaluating posts, comments, or other user generated content or communicated by the users of the various groups; evaluating and/or performing inferences based on user actions (e.g., likes or shares regarding purchase information etc.) internal to or external (e.g., product purchases made by users at brick and mortar stores, etc.) to the social networking system, etc. For example, data indicating the number of instances users in each of the groups have “liked” the target brand may be used to generate metrics related to the favorability of the target brand.

Based on the obtained data for the various groups, various metrics are 312 determined for the group of fans and for the FoF group. In one embodiment, the determined metrics are incremental values for the group of fans and for the FoF group. To calculate incremental values, the numbers of users in the group of fans and in the FoF group are determined. For example, the process may determine that the group of fans includes 1 million users and the FoF group includes 12 million users. Furthermore, the percentages of users in each of the group of fans, the FoF group and the control group that reported purchasing products associated with the brand are determined. For example, if two out of four fans in the group of fans that responded to the polls indicated that they purchased products associated with the brand, then it would be determined that fifty percent of the brand's fans purchased products associated with the brand. As used herein, such percentages may be referred to as “purchase percentages.”

Average purchase values for the group of fans and the FoF group are also determined. An average purchase value indicates, on a per user basis, the average amount spent and/or planned to be spent on products associated with the target brand by a group. The average purchase values may be determined in any suitable manner. In one embodiment, the average purchase values are determined based on answers to the polls received from the group of fans and from the FoF group. In another embodiment, the average purchase values are directly received from an advertiser or from another third party entity. For example, an advertiser may explicitly indicate that the average purchase value for the group of fans is 30 dollars. In another embodiment, average purchase values are determined based on purchase transactions performed over the social networking system 100 and/or external systems associated with the social networking system 100.

Based on purchase percentages and average purchase values, incremental values of the group of fans and of the FoF group are calculated. In one embodiment, the incremental values of the group of fans and of the FoF group are calculated using the following equation, where X is the group (e.g., the group of fans) being evaluated and Y (e.g., the control group) is the group to which group X is compared:

Incremental Value=(X_{purchase percentage}−Y_{purchase percentage})*X_{total number}*X_{average purchase value} (1)

Hence, the purchase percentage for the control group is subtracted from the purchase percentage of fans to generate an incremental purchase percentage. The incremental purchase percentage is multiplied by the number of fans and by the determined average purchase value for the group of fans to obtain the incremental value of the group of fans. In another embodiment, the purchase percentage for the FoF group is used rather than the purchase percentage of the control group. This allows the calculation of an incremental value comparing the group of fans to the FoF group rather than the control group. The incremental value for the FoF group may be similarly generated by subtracting the purchase percentage of the control group from the purchase percentage of the FoF group to generate an incremental purchase percentage, which is then multiplied by the determined number of users in the FoF group and by the determined average purchase value of the FoF group.

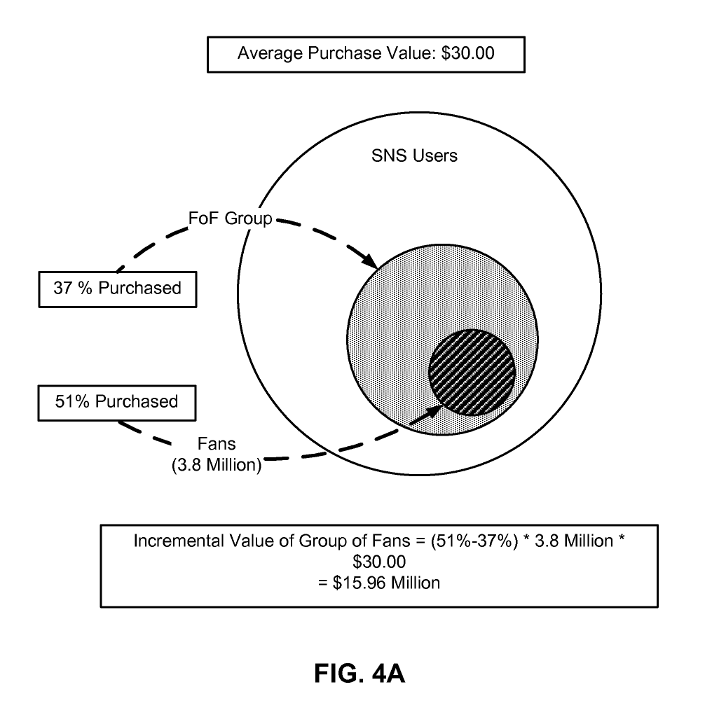

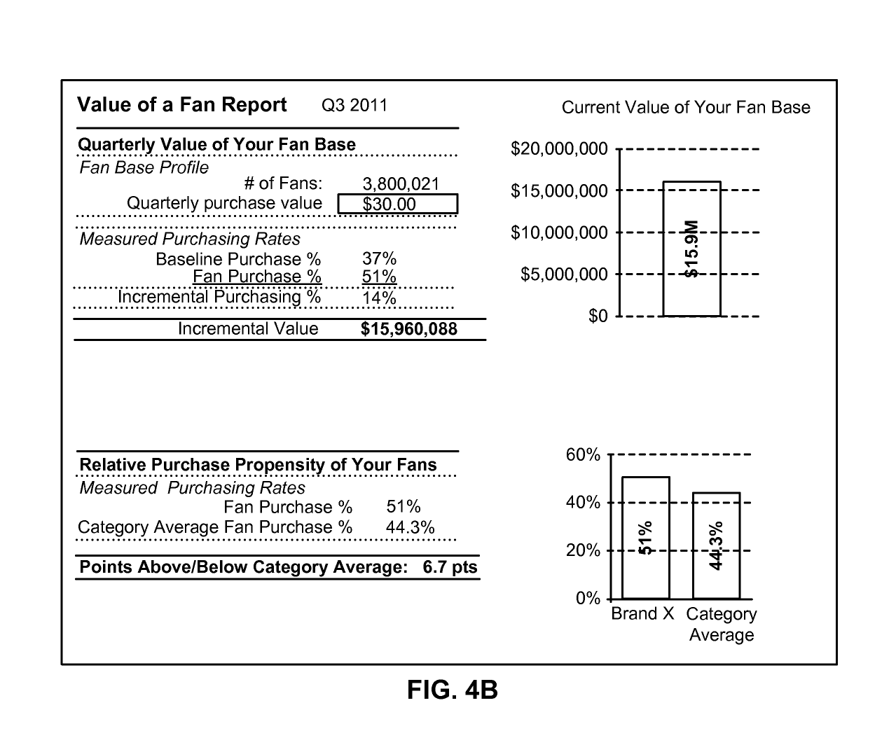

FIG. 4A shows a diagram illustrating generation of the incremental value for a group of fans. In FIG. 4A, the incremental value for the group of fans is calculated by comparing the group of fans to the FoF group. As shown by FIG. 4A, fifty-one percent of fans purchased products associated with a target brand and the thirty-seven percent of friends of the fans purchased products associated with the target brand. Further, the total number of fans is 3.8 million, and the average purchase value for the group of fans is thirty dollars. As such, the incremental value of the group of fans is calculated as (0.51−0.37)(3,800,000)($30), or $15.96 million.

In addition to calculating incremental values for the group of fans and the FoF group, metrics related to brand favorability, likelihood to recommend, and message resonance may also be determined. Brand favorability metrics indicate how favorably users in a group perceive the target brand. Metrics related to likelihood to recommend indicate the probability with which users in a group would suggest products associated with the target brand to others. Message resonance metrics indicate how closely users in a group identify with the core positioning of the target brand.

For the group of fans, metrics for brand favorability, likelihood to recommend, and message resonance are determined by comparing the polling answers associated with each metric from the group of fans against the polling answers for each metric from the control group (or the FoF group). Similarly for the FoF group, metrics for brand favorability, likelihood to recommend, and message resonance are determined by comparing the polling answers associated with each metric from the FoF group against the polling answers for each metric from the control group.

For example, polling questions provided to the group of friends, FoF group, and control group may ask users to rate the favorability of the target brand from a scale of 1 to 5. The average rating for the group of fans may be a rating of 5. The average rating for the FoF group may be a rating of 4. The average rating for the control group may be a rating of 2. Accordingly, the brand favorability metric for the group of fans is determined to be 3, which is the difference between the average rating for the group of fans and the average rating of the control group. Similarly, the brand favorability metric for the FoF group is determined to be 2, which is the difference between the average rating for the FoF group and the average rating of the control group.

After calculating the metrics, a report containing the determined metrics and other information (e.g., metric related numbers, percentages, charts, etc.) for the group of fans and the FoF group is generated 314. The generated report may be provided to an advertiser or any other suitable entity associated with the target brand. Referring to FIG. 4B, it shows an example report including various metrics for a group of fans. The example report of FIG. 4B indicates the number of fans for a particular brand and the average value of purchases for products associated with the brand (i.e., the value for quarterly consumer value). More specifically, FIG. 4B indicates that the brand has 3.8 million fans and an average purchase value of thirty dollars. The report also indicates a baseline purchase percentage (i.e., 37%), a purchase percentage for the group of fans (i.e., 51%), and the incremental purchase percentage for the group of fans (i.e., 14%). Further, the report provides the incremental value for the group of fans (i.e., $15.96 Million).

In one embodiment, the overall purchase percentages for a category associated with the target brand is also determined. More specifically, a particular category associated with the target brand is identified. Other brands also associated with the particular category may also be identified. For example, it can be determined that a particular soft drink brand is associated with a soda category. Thereafter, twenty other soft drink brands also associated with the soda category may be determined.

Subsequently, an overall purchase percentage for the category associated with the target brand is determined for the group of fans of the target brand. More specifically, for each brand in the category, a purchase percentage for a group of the brand's fans is determined and the purchase percentages for each group are averaged to determine an overall purchase percentage for the category. In one embodiment, the overall purchase percentage for the category may be included in the generated report, allowing advertisers to easily compare and contrast the purchase percentages for their target brands relative to the category associated with their brands. For example, referring to the report shown in FIG. 4B, the purchase percentage for the group of fans (i.e., 51%) of the target brand is shown in comparison to an overall purchase percentage for the category of the target brand (i.e., 44.3%). The report further includes the difference between the purchase percentage for the group of fans and the overall purchase percentage for the category of the target brand (i.e., 6.7 points).

In one aspect, characteristic profiles for the users of the group of fans of the target brand and/or of the FoF group of the target brand may also be determined. The characteristic profiles provide information regarding the general characteristics or attributes of the users in the group of fans of the target brand or in the FoF group. For example, the average ages of the users in a group, the gender breakdowns for a group, the geographical region breakdowns for a group or other similar information is included in a characteristic profile. General characteristics of the users of the groups may be based in part on the user profiles for the users in the groups, etc. For example, ages reported in the user profiles of the user in a group of fans of the target brand are averaged to determine a general age characteristic. General characteristics for the users may be included in the generated report.

### Process for Generating Metrics for Groups Using Holdout Subgroups

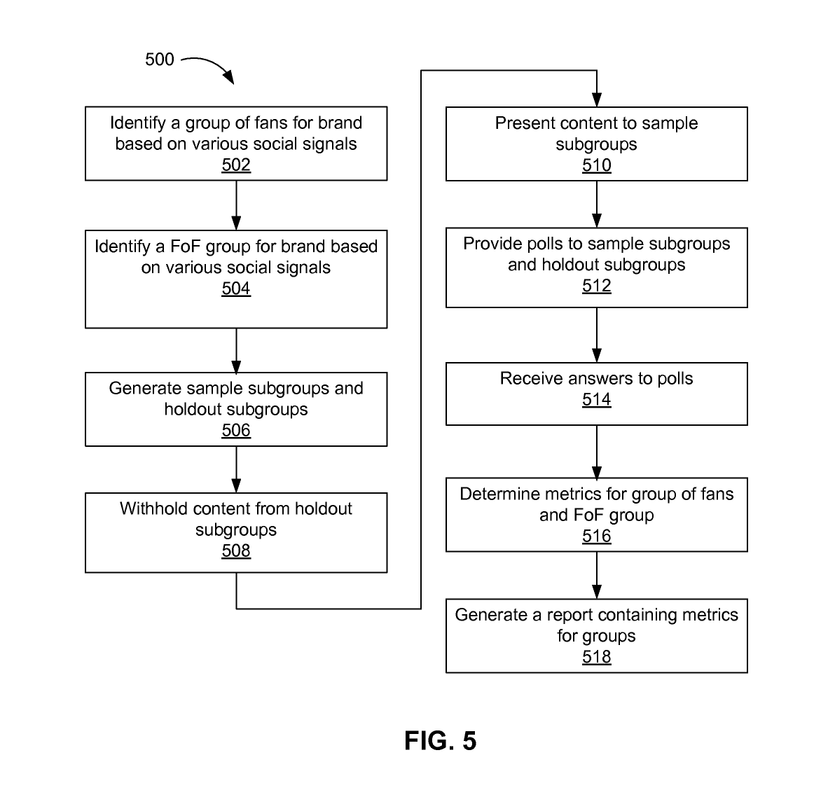

FIG. 5 illustrates one embodiment of a process 500 for generating metrics for groups using holdout subgroups. A group of fans for a target brand is identified 502 based on various social signals. In one embodiment, the group of fans is identified as the users of the social networking system 100 that have performed actions indicative of being a fan of the target brand, as further described above.

An FoF group is also identified 504 based on various social signals. As described above in conjunction with FIG. 3, users connected to each user in the group of fans of the target brand are identified. Users connected to at least one user in the group of fans of the target brand by a specified type of connection (e.g., a connection indicating a friendship) are included in the FoF group. Other criteria may be used to identify the FoF group in some embodiments. In some embodiments, the group of fans and the FoF group are identified 502, 504 as described above in conjunction with FIG. 3.

Sample subgroups and holdout subgroups are generated 506 for each of the group of fans of the target brand and the FoF group. Users from the group of fans are randomly or pseudo-randomly assigned to either a fan sample subgroup or to a fan holdout subgroup. In one embodiment, the holdout subgroup of the group of fans comprises 1% or less of the total number of users in the group of fans. Similarly, users from the FoF group are randomly or pseudo-randomly assigned to either a fan sample subgroup or a fan holdout subgroup. The FoF holdout subgroup may also include 1% or less of the total number of users in the FoF group.

Content related to the target brand presented via the social networking system 100 is withheld 508 from the holdout subgroups. Thus, for each of the holdout subgroups, advertisements, posts, comments, shared content, sponsored stories, social stories and/or any other content associated with the target brand is not presented to users in the holdout subgroups. For example, a friend of a user in the fan holdout subgroup may perform a “like” activity with respect to an advertisement of the target brand. While such a “like” activity is normally identified to other users connected to the friend performing the “like” activity, the “like” activity is not identified to the user in the fan holdout subgroup. However, content associated with the target brand is presented 510 to the sample subgroups. Thus, advertisements, posts, comments, shared content, sponsored stories, or any other content identified as being associated with the brand are sent to users in the sample subgroups.

For example, content associated with the target brand is selected for presentation to a user, and it is determined whether the user is in the fan holdout subgroup or the FoF holdout subgroup. If the user is in the fan holdout subgroup or in the FoF holdout subgroup, the content is withheld from being presented to the user. However, if the user is not in the holdout subgroups, and the user is either in the fan sample subgroup or in the FoF sample subgroup, the selected content is presented to the user.

After presenting the content, polls are provided 512 to each of the sample subgroups and each of the holdout subgroups. The polls may be similar to the polls provided to the various groups described above in conjunction with FIG. 3. Answers to questions in the polls are received 514 from users in the sample subgroups and in the holdout subgroups. Based on the received answers from the holdout subgroups and from the sample subgroups, one or more metrics are determined 516 for the group of fans and for the FoF group. In other embodiments, the data used to generate the metrics for the group of fans and the FoF group may be obtained through other means in addition to or alternatively to providing polling questions and receiving corresponding polling answers. For example, the data for the group of fans, FoF group, and/or control group needed to generate the various metrics for the group of fans and FoF group may be obtained through receiving answers to questions posted over the social networking system to the various groups; receiving answers to questions posed to friends of the fans or friends of the users in the FoF group; evaluating posts, comments, or other user generated content or communicated by the users of the various groups; evaluating and/or performing inferences based on user actions (e.g., likes or shares regarding purchase information etc.) internal to or external (e.g., product purchases made by users at brick and mortar stores, etc.) to the social networking system, etc.

In one aspect, incremental value metrics, brand favorability metrics, likelihood to recommend metrics, and message resonance metrics may be determined for each of the groups as described above in conjunction with FIG. 3. However, rather than comparing the group of fans and the FoF group to the control group, the sample subgroups are compared to the holdout subgroups. Therefore, metrics for the group of fans are determined from comparisons between the fan sample subgroup and the fan holdout subgroup. Similarly, metrics for the FoF group are determined from comparisons between the FoF sample subgroup and the FoF holdout subgroup. Hence, the calculated metrics describe the relative impact of the presentation of content for a target brand on the group of fans of the target brand and on the FoF group.

A report including the metrics for the group of fans of the target brand and/or the metrics for the FoF group are generated 518 as described above in conjunction with FIGS. 3 and 4B. The generated report may be provided to an advertiser or any other suitable entity associated with the target brand.

### Summary

The foregoing description of the embodiments of the invention has been presented for the purpose of illustration; it is not intended to be exhaustive or to limit the systems and methods to the precise forms disclosed. Persons skilled in the relevant art can appreciate that many modifications and variations are possible in light of the above disclosure.

Some portions of this description describe the embodiments of the systems and methods in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the systems and methods may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the systems and methods may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the systems and methods systems and methods be limited not by this detailed description, but rather by any claims that issue on an application based hereon. Accordingly, the disclosure of the embodiments of the systems and methods are intended to be illustrative, but not limiting, of the scope of the invention, which is set forth in the following claims.

What is claimed is:

1. A computer-implemented method comprising:
maintaining a plurality of connections in a social networking system between a plurality of users of the social networking system;
storing actions performed by the plurality of users of the social networking system on objects maintained by the social networking system;
determining a group of fans for a target brand from the plurality of users of the social networking system, the group of fans including one or more users of the social networking system who have each performed at least one action from a set of predetermined actions on one or more objects maintained by the social networking system associated with the target brand;
identifying a control group from the plurality of users of the social networking system, the control group including one or more users who have not performed at least one action from the set of predetermined actions on one or more objects maintained by the social networking system associated with the target brand;
obtaining data for users in the group of fans and data for users in the control group; and
calculating a metric for the group of fans based on a comparison between the data for users in the group of fans and the data for users in the control group.

2. The computer-implemented method of claim 1, wherein obtaining the data comprises:
providing one or more polling questions to users in the group of fans and users in the control group; and
receiving one or more answers to the polling questions from users in the group of fans and users in the control group.

3. The method of claim 1, wherein calculating the metric for the groups of fans comprises:
determining a percentage of users in the group of fans that purchased products associated with the target brand based on the data for users in the group of fans;
determining a percentage of users in the control group that purchased products associated with the target brand based on the data for users in the control group;
calculating an incremental percentage by subtracting the percentage of users in the control group that purchased products associated with the target brand from the percentage of users in the group of fans that purchased products associated with the target brand; and
calculating an incremental value for the group of fans by multiplying the incremental percentage by a number of users in the group of fans and by an average value for products purchased by the users in the group of fans.

4. The method of claim 1, wherein the metric measures an incremental value for the group of fans relative to the control group.

5. The method of claim 1, further comprising:
identifying a friends of fans (FoF) group for the target brand from the plurality of users of the social networking system, the FoF group including one or more users of the social networking system having a connection to at least one user in the group of fans;
obtaining data for users in the FoF group; and
calculating a metric for the FoF group based on a comparison of the data for users in the FoF group and data for users in the control group.

6. The method of claim 5, wherein each of the users in the FoF group have a friendship type connection to at least one user in the group of fans.

7. The method of claim 5, further comprising:
calculating an additional metric for the group of fans based on a comparison between the data for users in the group of fans and the data for users in the FoF group.

8. The method of claim 7, wherein the additional metric measures an incremental value of the group of fans relative to the FoF group.

9. The method of claim 1, wherein the at least one action from the set of predetermined actions performed on one or more objects maintained by the social networking system associated with the target brand is selected from a group consisting of: (1) an action indicating a preference for an object associated with the target brand and (2) an action establishing a fan type connection to an object associated with the target brand.

10. The method of claim 1, further comprising:
determining a set of representative user characteristics associated with users in the group of fans based at least in part on one or more user profiles associated with the users in the group of fans, the one or more user profiles being maintained by the social networking system.

11. The method of claim 1, wherein the control group is associated with a set of user characteristics statistically similar to a set of user characteristics associated with the group of fans.

12. A computer-implemented method comprising:
maintaining a plurality of connections in a social networking system between a plurality of users of the social networking system;
storing actions performed by the plurality of users of the social networking system on one or more objects maintained by the social networking system;
determining a group of fans for a target brand from the plurality of users of the social networking system, the group of fans including one or more users of the social networking system that have performed at least one action from a set of predetermined actions on one or more objects maintained by the social networking system associated with the target brand;
generating a holdout subgroup for the group of fans including a subset of users from the group of fans;
selecting content associated with the target brand for sending to users in the group of fans;
sending the selected content associated with the target brand to users in the group of fans, wherein the sending comprises:
determining whether a user of the group of fans is in the holdout subgroup;
responsive to a determination that the user is in the holdout subgroup for the group of fans, preventing sending of the content associated with the target brand to the user;
responsive to a determination that the user is not in the holdout subgroup for the group of fans, sending the content associated with the target brand to the user;
providing one or more polling questions to users in the group of fans;
receiving answers to the polling questions from users in the group of fans; and
calculating a metric measuring an effectiveness of content associated with the target brand on the group of fans based at least in part on a comparison between (1) received answers to the polling questions from users in the holdout subgroup for the group of fans and (2) received answers to the polling questions from users of the group of fans not in the holdout subgroup for the group of fans.

13. The method of claim 12, further comprising:
identifying a friends of fans (FoF) group for the target brand from the plurality of users of the social networking system, the FoF group including one or more users of the social networking system having a connection to at least one user in the group of fans;
generating a holdout subgroup for the FoF group including a subset of users in the FoF group;
sending the selected content associated with the target brand to users in the FoF group, wherein sending the selected content to users in the FoF group comprises:
determining whether a user is in the holdout subgroup for the FoF group;
responsive to a determination that the user is in the holdout subgroup for the FoF group, preventing sending of the content associated with the target brand to the user;
responsive to a determination that the user is not in the holdout subgroup for the FoF group, sending the content associated with the target brand to the user;
providing one or more polling questions to users of the social networking system in the FoF group;
receiving answers to the polling questions from users in the FoF group; and
calculating a metric measuring an effectiveness of content associated with the target brand on the FoF group based on a comparison between (1) received answers from users in the holdout subgroup of the FoF group and (2) received answers from users of the FoF group not in the holdout subgroup of the FoF group.

14. The method of claim 12, wherein the selected content associated with the target brand comprises at least one of an advertisement associated with the target brand or a post associated with the target brand.

15. The method of claim 12, wherein sending the selected content associated with the target brand comprises:
sending a story describing a user interaction performed on an object maintained by the social networking system associated with the target brand to a particular user in the group of fans not in the holdout subgroup for the group of fans, the user interaction performed by another user connected to the particular user.

16. The method of claim 12, wherein a number of users in the holdout subgroup for the group of fans is less than or equal to one percent of a number of users in the group of fans.

17. A computer-implemented method comprising:
identifying a group of fans for a brand based on social signals associated with users of a social networking system;
identifying a group of non-fans for the brand based on social signals associated with users of the social networking system;
calculating an incremental value for the group of fans based on purchase information for the group of fans and based on purchase information for the group of non-fans;
generating a report including the incremental value for the group of fans; and
sending the report to a user.

18. The method of claim 17, wherein identifying the group of fans for the brand based on social signals associated with users of a social networking system comprises:
identifying a user of a social networking system having an affinity for the brand equaling or exceeding an affinity threshold, the affinity for the brand based at least in part on one or more actions performed by the user on one or more objects maintained by the social networking system and associated with the brand; and
including the identified user of the social networking system in the group of fans.

19. The method of claim 18, wherein an object maintained by the social networking system and associated with the brand is at least one of a fan page, an advertisement, a comment, or a post.

20. The method of claim 17, wherein identifying the group of non-fans for the brand based on social signals associated with users of the social networking system comprises:
identifying a user of the social networking system having an affinity for the brand less than an affinity threshold; and
including the identified user in the group of non-fans.

21. The method of claim 17, wherein the purchase information for the group of fans includes (1) a percentage of the group of fans that purchased one or more products associated with the brand and (2) an average per user purchase value for the one or more products.
